(19) United States
(12) Patent Application Publication
(10) Pub. No.: US 2018/0312383 A1
(43) Pub. Date: Nov. 1, 2018

(54) Part-Gripping Carrier

(71) Applicant: SupplyOne Rockwell,Inc., Rockwell, SC (US)

(72) Inventor: Myron Edward Bostian, Gold Hill, NC (US)

(21) Appl. No.: 16/025,933

(22) Filed: Jul. 2, 2018

Related U.S. Application Data
(63) Continuation-in-part of application No. 15/695,869, filed on Sep. 5, 2017.
(60) Provisional application No. 62/527,613, filed on Jun. 30, 2017.
(60) Provisional application No. 62/383,222, filed on Sep. 2, 2016.

(51) Int. Cl. B66F 9/18; B62D 65/02; B65D 19/20; B65D 85/68; B65D 81/02

(52) U.S. Cl. CPC B66F 9/18; B62D 65/022; B65D 19/20; B65D 85/68; B65D 81/025; B65D 2519/00815; B65D 2519/00019; B65D 2519/00054; B65D 2519/00159; B65D 2519/00502; B65D 2519/00273

(57) ABSTRACT

A part-gripping carrier is an apparatus that carries a particular automobile part through several progressions of the manufacturing process. In addition to carrying the automobile part through the manufacturing process, the part-gripping carrier can then be used to ship the part, thus reducing the risk of accidentally damaging the part through the manufacturing process and the shipping. The part-gripping carrier includes a base panel, a first lateral-bracing portion, a second lateral-bracing portion, a first tapered panel, and a second tapered panel. The base panel acts as a support surface for a particular automobile part. The first lateral-bracing portion and the second lateral-bracing portion act as gripping elements to maintain the particular automobile part inside of the present invention. The first tapered panel and the second tapered panel provide cushion distance which protect the ends of the particular automobile part when inside of the present invention.

The current application claims a priority to the U.S. Provisional Patent application Ser. No. 62/527,613 filed on Jun. 30, 2017. The current application is filed on Jul. 2, 2018 while Jun. 30, 2017 was on a weekend.

### FIELD OF THE INVENTION

The present invention relates generally to part carriers and production line tools. More specifically, the present invention refers to a part-gripping carrier for automobile parts manufacturing.

### BACKGROUND OF THE INVENTION

It is common for parts in an assembly line or production line to be carried by a secondary device throughout the process. These secondary devices are custom made to carry a particular part or object and to fit a specific machine. Another problem with the currently available carriers is that workers often have to handle or reposition the part resting on the carrier device, which oftentimes requires the worker to use tools to loosen the part and secure it again after moving it. In addition, the material used for these secondary devices are often expensive and are made to be reused a multiple number of times. Thus, the problem arises that the same secondary device cannot be used for different processes during the production process, such as coating processes and testing. Furthermore, most of these secondary devices cannot be used to ship the products which results in the part being removed from one secondary device to a different secondary device for shipping. The time required to move the part from one carrier device to another increase greatly and the risk of damaging the part from an accidental drop or contact with another object increases as well. Plus, the whole process increases labor and makes the whole manufacturing costly and time consuming. Thus, a carrier is needed that can be used for different parts of the same manufacturing process which eliminates the needs of different carriers and can be used for shipping as well is needed.

An objective of the present invention is to provide a part-gripping carrier which carries a part through several processes of the same manufacturing process. The benefit of using a single carrier over different processes eliminates the need to move the part constantly from one carrier to another, which in turn saves time and makes the manufacturing process faster. In addition, because the part is handled less often, the risk of accidentally damaging the part during the manufacturing process if decreased as well. Another objective of the present invention is to provide a part-gripping carrier which is made from corrugated fiberboard. The use of corrugated fiberboard provides an inexpensive and replaceable carrier which is relatively light and strong enough to provide a secure support to the part throughout the manufacturing process. Another objective of the present invention is to provide a part-gripping carrier which can be used for the shipping of the part after the manufacturing process. The ability to use the same carrier for the part throughout the manufacturing process and the shipping reduces the risk of the part being accidentally damaged plus reduces the labor time, thus reducing the time required to manufacture and deliver the part. Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a left-side perspective view of the present invention.

FIG. 2 is a top view of the present invention in an unfolded configuration.

FIG. 3 is a right-side view of the present invention.

FIG. 4 is a top view of the present invention.

FIG. 5 is a bottom view of the present invention.

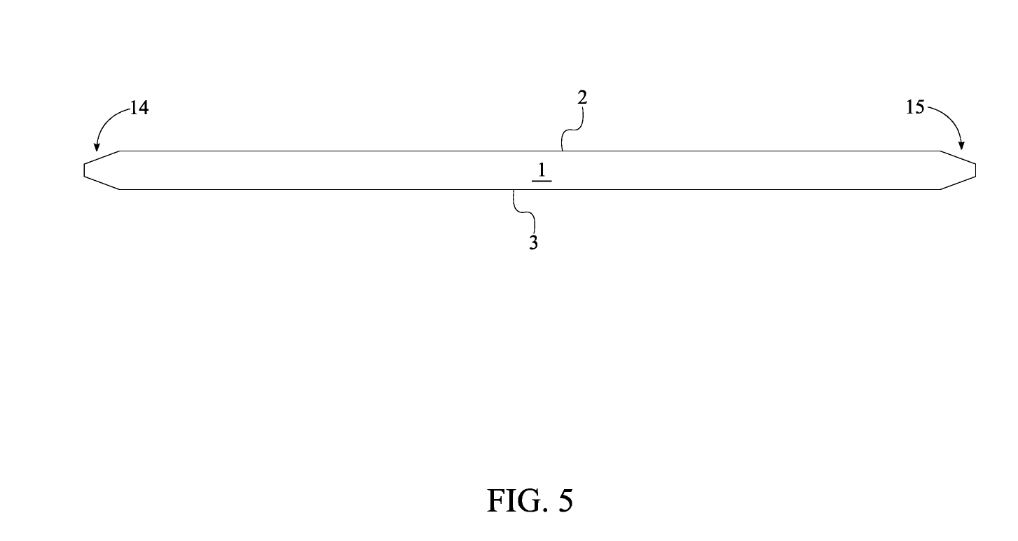

FIG. 6 is a cross-sectional view of section 6-6 from FIG. 3.

### DETAIL DESCRIPTIONS OF THE INVENTION

All illustrations of the drawings are for the purpose of describing selected versions of the present invention and are not intended to limit the scope of the present invention.

The present invention is a part-gripping carrier that carries a particular automobile part through several progressions of the manufacturing process such as the coating processes and the testing process. In addition to carrying the automobile part through the manufacturing process, the present invention can then be used to ship the part, thus reducing the risk of accidentally damaging the part through the manufacturing process and the shipping. Furthermore, the present invention is preferably composed of corrugated fiberboard material and essentially acts as a rigid glove to straighten and protect the particular automobile part through various process of the manufacture process. The present invention comprises a base panel 1, a first lateral-bracing portion 4, a second lateral-bracing portion 5, a first tapered panel 14, and a second tapered panel 15. The base panel 1 acts as a support surface for a particular automobile part. The first lateral-bracing portion 4 and the second lateral-bracing portion 5 act as gripping elements to maintain the particular automobile part inside of the present invention. The first tapered panel 14 and the second tapered panel 15 act as bumper elements which protects the ends of the particular automobile part when inside of the present invention.

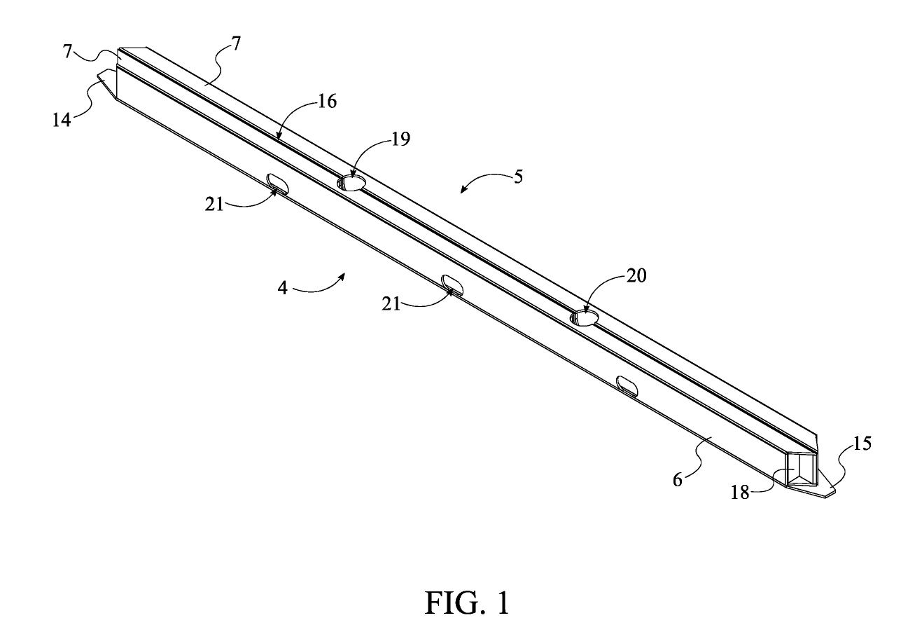

The general configuration of the aforementioned components allows a particular automobile part to be carried through several processes of the manufacturing process such as the coating process and the testing process. As seen in FIGS. 1,2, and 5, the base panel 1 comprises a first lengthwise edge 2 and a second lengthwise edge 3. The first lateral-bracing portion 4 is hingedly and adjacently connected along the first lengthwise edge 2. This arrangement allows the first lateral-bracing portion 4 to be folded about the first lengthwise edge 2. Similarly, the second lateral-bracing portion 5 is hingedly and adjacently connected along the second lengthwise edge 3. This arrangement allows the second lateral-bracing portion 5 to be folded about the second lengthwise edge 3. In addition, the first tapered panel 14 and the second tapered panel 15 are positioned in between the first lengthwise edge 2 and the second lengthwise edge 3. The first tapered panel 14 is terminally connected to the base panel 1. The second tapered panel 15 is terminally connected to the base panel 1, opposite the first tapered panel 14. The first tapered panel 14, the second tapered panel 15, and the base panel 1 are positioned coplanar to each other. This arrangement allows the first tapered panel 14 and the second tapered panel 15 to create a cushion distance for the ends of the part inside the present invention. The first lateral-bracing portion 4 and the second lateral-bracing portion 5 are positioned offset to each other by a part-receiving gap 16. The part-receiving gap 16 allows the present invention to receive a particular automobile part. This arrangement allows the first lateral-bracing portion 4 and the second lateral-bracing portion 5 to grip the particular automobile part when inside the part-receiving gap 16.

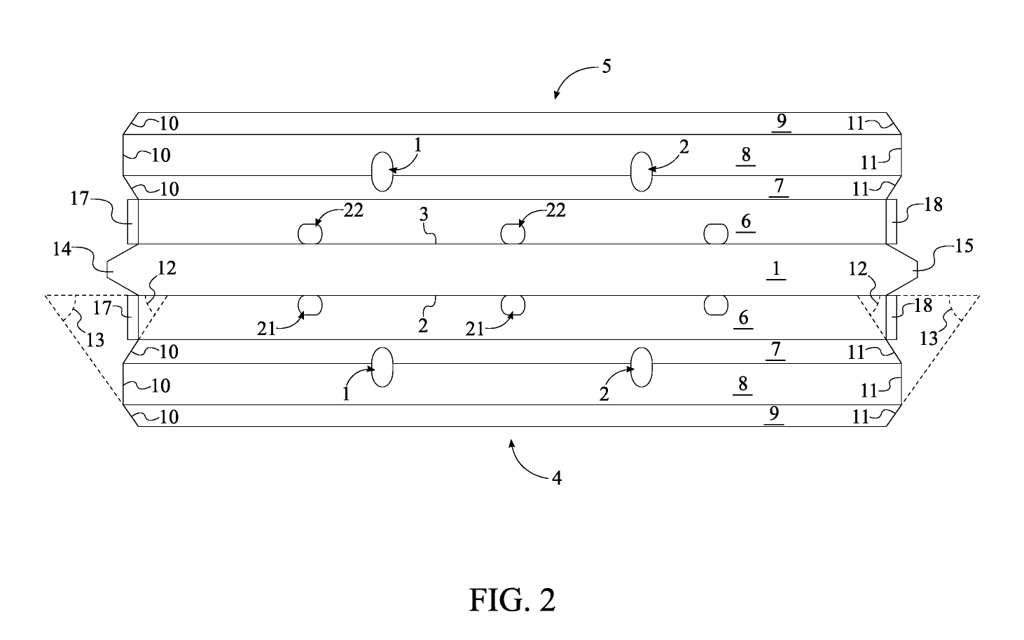

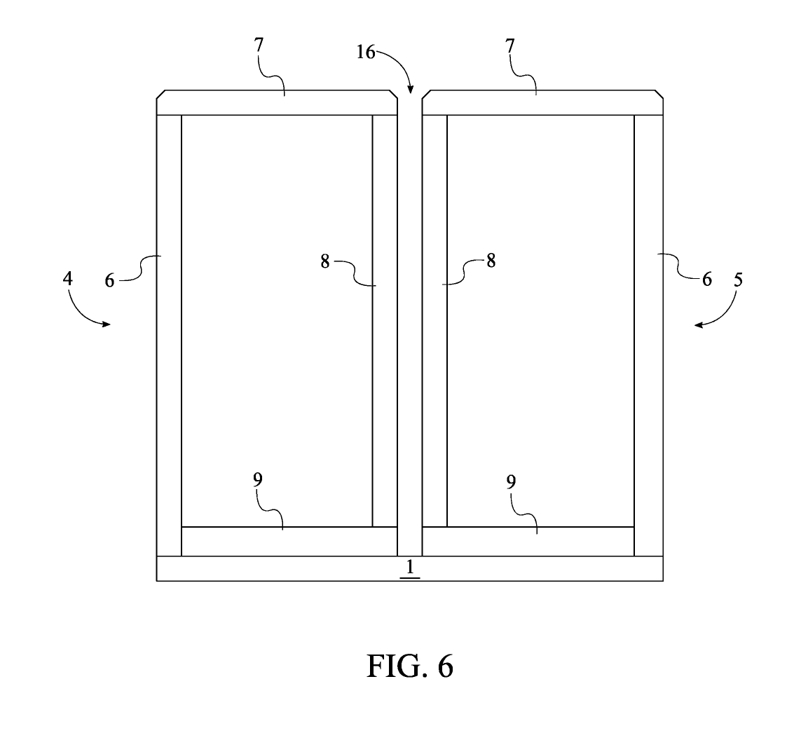

In order for the present invention to be properly shaped to carry the particular automobile part and as seen in FIGS. 2 and 6, the first lateral-bracing portion 4 and the second lateral-bracing portion 5 each comprise an outer panel 6, a top panel 7, an inner panel 8, and a bottom panel 9. The outer panel 6, the bottom panel 9, the inner panel 8, and the bottom panel 9 are pieces that can be folded into a tubular shape. The outer panel 6 and the inner panel 8 are positioned perpendicular to the base panel 1. The top panel 7 and the bottom panel 9 are positioned parallel to the base panel 1. The bottom panel 9 is pressed against the base panel 1. This arrangement forms a square tubular box shape for each the first lateral-bracing portion 4 and the second lateral-bracing portion 5. Furthermore, this arrangement creates hollow spaces within the first lateral-bracing portion 4 and the second lateral-bracing portion 5 that act as cushion elements when the particular automobile part is inside the part-receiving gap 16.

In order for the first lateral-bracing portion 4 and the second lateral-bracing portion 5 to be unfolded from the square tubular box shape and with reference to FIG. 2, the outer panel 6 of the first lateral-bracing portion 4 is foldably and adjacently connected to the first lengthwise edge 2. This arrangement allows the outer panel 6 of the first lateral-bracing portion 4 to be folded about the first lengthwise edge 2. The top panel 7 of the first lateral bracing portion is foldably and adjacently connected to the outer panel 6 of the first lateral-bracing portion 4, opposite the first lengthwise edge 2. This arrangement allows the top panel 7 of the first lateral bracing portion to be folded about the outer panel 6 of the first lateral-bracing portion 4. Similarly, the outer panel 6 of the second lateral-bracing portion 5 is foldably and adjacently connected to the second lengthwise edge 3. This arrangement allows the outer panel 6 of the second lateral-bracing portion 5 to be folded about the second lengthwise edge 3. The top panel 7 of the second lateral-bracing portion 5 is foldably and adjacently connected to the outer panel 6 of the second lateral-bracing portion 5, opposite the second lengthwise edge 3. This arrangement allows the top panel 7 of the second lateral-bracing portion 5 to be folded about the outer panel 6 of the second lateral-bracing portion 5. Moreover, the inner panel 8 is foldably and adjacently connected to the top panel 7, opposite the outer panel 6. This arrangement allows the inner panel 8 to be folded about the top panel 7. The bottom panel 9 is foldably and adjacently connected to the inner panel 8, opposite the top panel 7. This arrangement allows the bottom panel 9 to be folded about the inner panel 8. Furthermore, the arrangement for both the first lateral-bracing portion 4 and the second lateral-bracing portion 5 between the outer panel 6, the top panel 7, the inner panel 8, and the bottom panel 9 allows the first lateral-bracing portion 4 and the second lateral-bracing portion 5 to be unfolded from the box shape

In order for both the first lateral-bracing portion 4 and the second lateral-bracing portion 5 to maintain a square tubular box shape and with reference to FIG. 2, the first lateral-bracing portion 4 and the second lateral-bracing portion 5 each further comprise a first folding tab 17 and a second folding tab 18. The first folding tab 17 and the second folding tab 18 allow the first lateral-bracing portion 4 and the second lateral-bracing portion 5 to maintain the box shape. The first folding tab 17 and the second folding tab 18 are positioned in between the base panel 1 and the top panel 7. The first folding tab 17 is peripherally and foldably connected to the outer panel 6. The second folding tab 18 is peripherally and foldably connected to the outer panel 6, opposite the first folding tab 17. This arrangement allows the first folding tab 17 and the second folding tab 18 to be folded within the hollow space delineated by outer panel 6, the inner panel 8, the top panel 7, and the bottom panel 9.

In order for the particular automobile part to be maintained within the part-receiving gap 16 without a user handling the present invention and with reference to FIG. 2, the top panel 7, the inner panel 8, and the bottom panel 9 each comprise a first widthwise edge 10. The first widthwise edge 10 is positioned adjacent to the first tapered panel 14. The first widthwise edge 10 of the of the inner panel 8 is positioned perpendicular to the first lengthwise edge 2. The first widthwise edge 10 of the top panel 7 is oriented at a top acute angle 12 with the first lengthwise edge 2. The first widthwise edge 10 of the bottom panel 9 is oriented at a bottom acute angle 13 with the first lengthwise edge 2. The top acute angle 12 and the bottom acute angle 13 form a slanted shape for an end of the first lateral-bracing portion 4 and the second lateral-bracing portion 5. The top acute angle 12 and the bottom acute angle 13 are equal and opposite to each other. This arrangement allows the first lateral-bracing portion 4 and the second lateral-bracing portion 5 to provide air pressure to an end of the particular automobile part. More specifically, when the present invention is in a resting state, tapered ends of the first-lateral bracing portion 4 and the second lateral-bracing portion 5 provide air pressure towards the part-receiving gap 16.

Similarly, the top panel 7, the inner panel 8, and the bottom panel 9 each comprise a second widthwise edge 11. The second widthwise edge 11 is positioned adjacent to the second tapered panel 15. The second widthwise edge 11 of the inner panel 8 is positioned perpendicular to the first lengthwise edge 2. The second widthwise edge 11 of the top panel 7 is oriented at a top acute angle 12 with the first lengthwise edge 2. The top acute angle 12 and the bottom acute angle 13 form a tapered shaped for an end of the first lateral-bracing portion 4 and the second lateral-bracing portion 5. The second widthwise edge 11 of the bottom panel 9 is oriented at a bottom acute angle 13 with the first lengthwise edge 2. The top acute angle 12 and the bottom acute angle 13 being equal and opposite to each other. This arrangement allows the first lateral-bracing portion 4 and the second lateral-bracing portion 5 to provide air pressure to an end of the particular automobile part. More specifically, when the present invention is in a resting state, opposite tapered ends of the first-lateral bracing portion 4 and the second lateral-bracing portion 5 provide air pressure towards the part-receiving gap 16.

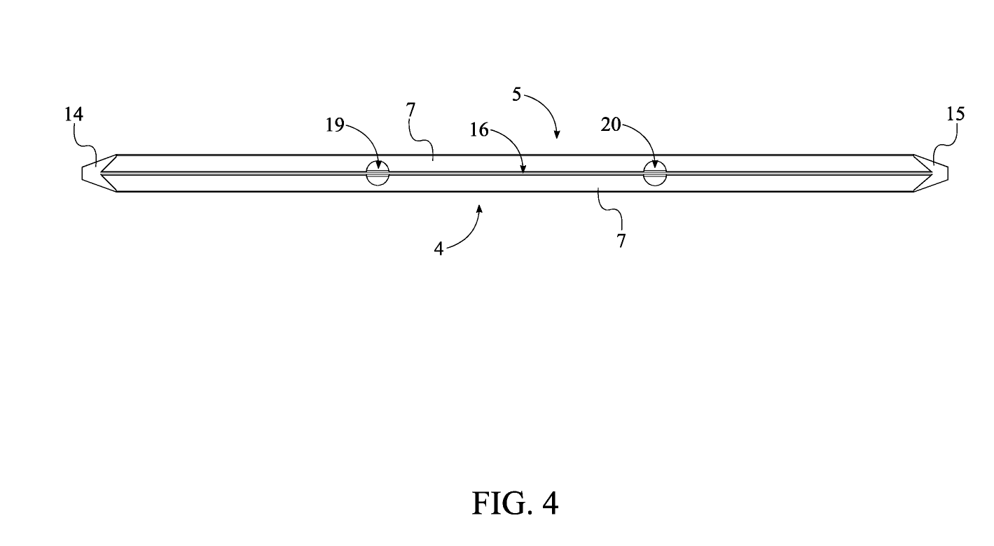

As seen in FIGS. 1 and 4, the present invention may further comprise a first orifice 19 and a second orifice 20. The first orifice 19 and the second orifice 20 allow a user to access the particular automobile part when inside of the part-receiving gap 16. The first orifice 19 and the second orifice 20 are positioned offset from each other along the part-receiving gap 16. The first orifice 19 and the second orifice 20 traverse through the first lateral-bracing portion 4 and the second lateral bracing portion. The first orifice 19 and the second orifice 20 intersects the part-receiving gap 16. This arrangement allows a user to easily connect the present invention to machinery used in the manufacture process and to handle present invention along with the particular automobile part.

As seen in FIG. 1, the present invention may further comprise a plurality of first orifices 21. The plurality of first orifices 21 provides staple access for a user during construction of the present invention. The plurality of first orifices 21 traverses into the first lateral-bracing portion 4. The plurality of first orifices 21 is positioned adjacent to and distributed along the first lengthwise edge 2. This arrangement allows the user to staple the first lateral-bracing portion 4 to maintain the box shape.

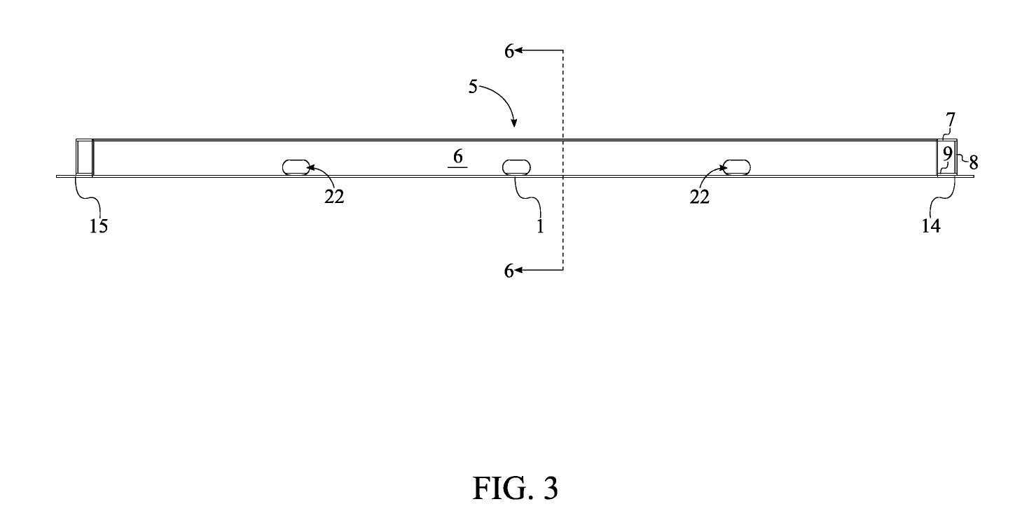

As seen in FIG. 3, the present invention may further comprise a plurality of second orifices 22. Similar to the plurality of first orifices 21, the plurality of second orifices 22 provides staple access for a user during construction of the present invention. The plurality of second orifices 22 traverses into the second lateral-bracing portion 5. The plurality of second orifices 22 is positioned adjacent to and distributed along the second lengthwise edge 3. This arrangement allows the user to staple the second lateral-bracing portion 5 to maintain the square tubular box shape.

Although the invention has been explained in relation to its preferred embodiment, it is to be understood that many other possible modifications and variations can be made without departing from the spirit and scope of the invention as hereinafter claimed.

What is claimed is:

1. A part-gripping carrier comprises:
a base panel;
a first lateral-bracing portion;
a second lateral-bracing portion;
a first tapered panel;
a second tapered panel;
the base panel comprises a first lengthwise edge and a second lengthwise edge;
the first lateral-bracing portion being hingedly and adjacently connected along the first lengthwise edge;
the second lateral-bracing portion being hingedly and adjacently connected along the second lengthwise edge;
the first tapered panel and the second tapered panel being positioned in between the first lengthwise edge and the second lengthwise edge;
the first tapered panel being terminally connected to the base panel;
the second tapered panel being terminally connected to the base panel, opposite the first tapered panel;
the first tapered panel, the second tapered panel, and the base panel being positioned coplanar to each other; and
the first lateral-bracing portion and the second lateral-bracing portion being positioned offset to each other by a part-receiving gap.

2. The part-gripping carrier as claimed in claim 1 comprises:
the first lateral-bracing portion and the second lateral-bracing portion each comprise an outer panel, a top panel, an inner panel, and a bottom panel;
the outer panel being positioned perpendicular to the base panel;
the top panel being positioned parallel to the base panel;
the inner panel being positioned perpendicular to the base panel;
the bottom panel being positioned parallel to the base panel; and
the bottom panel being pressed against the base panel.

3. The part-gripping carrier as claimed in claim 2 comprises:
the outer panel of the first lateral-bracing portion being foldably and adjacently connected to the first lengthwise edge;
the top panel of the first lateral-bracing portion being foldably and adjacently connected to the outer panel of the first lateral-bracing portion, opposite the first lengthwise edge;
the outer panel of the second lateral-bracing portion being foldably and adjacently connected to the second lengthwise edge;
the top panel of the second lateral-bracing portion being foldably and adjacently connected to the outer panel of the second lateral-bracing portion, opposite the second lengthwise edge;
the inner panel being foldably and adjacently connected to the top panel, opposite the outer panel; and
the bottom panel being foldably and adjacently connected to the inner panel, opposite the top panel.

4. The part-gripping carrier as claimed in claim 2 comprises:
the first lateral-bracing portion and the second lateral-bracing portion each further comprise a first folding tab and a second folding tab;
the first folding tab and the second folding tab being positioned in between the base panel and the top panel;
the first folding tab being peripherally and foldably connected to the outer panel; and
the second folding tab being peripherally and foldably connected to the outer panel, opposite the first folding tab.

5. The part-gripping carrier as claimed in claim 2 comprises:
the top panel, the inner panel, and the bottom panel each comprise a first widthwise edge;
the first widthwise edge being positioned adjacent to the first tapered panel;
the first widthwise edge of the inner panel being positioned perpendicular to the first lengthwise;
the first widthwise edge of the top panel being oriented at a top acute angle with the first lengthwise edge;
the first widthwise edge of the bottom panel being oriented at a bottom acute angle with the first lengthwise edge; and
the top acute angle and the bottom acute angle being equal and opposite to each other.

6. The part-gripping carrier as claimed in claim 2 comprises:
the top panel, the inner panel, and the bottom panel each comprise a second widthwise edge;
the second widthwise edge being positioned adjacent to the second tapered panel;
the second widthwise edge of the inner panel being positioned perpendicular to the first lengthwise;
the second widthwise edge of the top panel being oriented at a top acute angle with the first lengthwise edge;
the second widthwise edge of the bottom panel being oriented at a bottom acute angle with the first lengthwise edge; and
the top acute angle and the bottom acute angle being equal and opposite to each other.

7. The part-gripping carrier as claimed in claim 1 comprises:
a first orifice;
a second orifice;
the first orifice and the second orifice being positioned offset from each other along the part-receiving gap;
the first orifice and the second orifice traversing through the first lateral-bracing portion and the second lateral-bracing portion; and
the first orifice and the second orifice intersecting the part-receiving gap.

8. The part-gripping carrier as claimed in claim 1 comprises:
a plurality of first orifices;
the plurality of first orifices traversing into the first lateral-bracing portion;
the plurality of first orifices being positioned adjacent to the first lengthwise edge; and
the plurality of first orifices being distributed along the first lengthwise edge.

9. The part-gripping carrier as claimed in claim 1 comprises:
a plurality of second orifices;
the plurality of second orifices traversing into the second lateral-bracing portion;
the plurality of second orifices being positioned adjacent to the second lengthwise edge; and
the plurality of second orifices being distributed along the second lengthwise edge.

10. A part-gripping carrier comprises:
a base panel;
a first lateral-bracing portion;
a second lateral-bracing portion;
a first tapered panel;
a second tapered panel;
the base panel comprises a first lengthwise edge and a second lengthwise edge;
the first lateral-bracing portion and the second lateral-bracing portion each comprise an outer panel, a top panel, an inner panel, and a bottom panel;
the first lateral-bracing portion being hingedly and adjacently connected along the first lengthwise edge;
the second lateral-bracing portion being hingedly and adjacently connected along the second lengthwise edge;
the first tapered panel and the second tapered panel being positioned in between the first lengthwise edge and the second lengthwise edge;
the first tapered panel being terminally connected to the base panel;
the second tapered panel being terminally connected to the base panel, opposite the first tapered panel;
the first tapered panel, the second tapered panel, and the base panel being positioned coplanar to each other;
the first lateral-bracing portion and the second lateral-bracing portion being positioned offset to each other by a part-receiving gap;
the outer panel being positioned perpendicular to the base panel;
the top panel being positioned parallel to the base panel;
the inner panel being positioned perpendicular to the base panel;
the bottom panel being positioned parallel to the base panel; and
the bottom panel being pressed against the base panel.

11. The part-gripping carrier as claimed in claim 10 comprises:
the outer panel of the first lateral-bracing portion being foldably and adjacently connected to the first lengthwise edge;
the top panel of the first lateral-bracing portion being foldably and adjacently connected to the outer panel of the first lateral-bracing portion, opposite the first lengthwise edge;
the outer panel of the second lateral-bracing portion being foldably and adjacently connected to the second lengthwise edge;
the top panel of the second lateral-bracing portion being foldably and adjacently connected to the outer panel of the second lateral-bracing portion, opposite the second lengthwise edge;
the inner panel being foldably and adjacently connected to the top panel, opposite the outer panel; and
the bottom panel being foldably and adjacently connected to the inner panel, opposite the top panel.

12. The part-gripping carrier as claimed in claim 10 comprises:
the first lateral-bracing portion and the second lateral-bracing portion each further comprise a first folding tab and a second folding tab;
the first folding tab and the second folding tab being positioned in between the base panel and the top panel;
the first folding tab being peripherally and foldably connected to the outer panel; and
the second folding tab being peripherally and foldably connected to the outer panel, opposite the first folding tab.

13. The part-gripping carrier as claimed in claim 10 comprises:
the top panel, the inner panel, and the bottom panel each comprise a first widthwise edge and a second widthwise edge;
the first widthwise edge being positioned adjacent to the first tapered panel;
the first widthwise edge of the inner panel being positioned perpendicular to the first lengthwise;
the first widthwise edge of the top panel being oriented at a top acute angle with the first lengthwise edge;
the first widthwise edge of the bottom panel being oriented at a bottom acute angle with the first lengthwise edge;
the top acute angle and the bottom acute angle being equal and opposite to each other;
the second widthwise edge being positioned adjacent to the second tapered panel;
the second widthwise edge of the inner panel being positioned perpendicular to the first lengthwise;
the second widthwise edge of the top panel being oriented at a top acute angle with the first lengthwise edge;
the second widthwise edge of the bottom panel being oriented at a bottom acute angle with the first lengthwise edge; and
the top acute angle and the bottom acute angle being equal and opposite to each other.

14. The part-gripping carrier as claimed in claim 10 comprises:
a first orifice;
a second orifice;
the first orifice and the second orifice being positioned offset from each other along the part-receiving gap;
the first orifice and the second orifice traversing through the first lateral-bracing portion and the second lateral-bracing portion; and
the first orifice and the second orifice intersecting the part-receiving gap.

15. The part-gripping carrier as claimed in claim 10 comprises:
a plurality of first orifices;
a plurality of second orifices;
the plurality of first orifices traversing into the first lateral-bracing portion;
the plurality of first orifices being positioned adjacent to the first lengthwise edge;
the plurality of first orifices being distributed along the first lengthwise edge;
the plurality of second orifices traversing into the second lateral-bracing portion;
the plurality of second orifices being positioned adjacent to the second lengthwise edge; and
the plurality of second orifices being distributed along the second lengthwise edge.

16. A part-gripping carrier comprises:
a base panel;
a first lateral-bracing portion;
a second lateral-bracing portion;
a first tapered panel;
a second tapered panel;
a first orifice;
a second orifice;
the base panel comprises a first lengthwise edge and a second lengthwise edge;
the first lateral-bracing portion and the second lateral-bracing portion each comprise an outer panel, a top panel, an inner panel, and a bottom panel;
the first lateral-bracing portion being hingedly and adjacently connected along the first lengthwise edge;
the second lateral-bracing portion being hingedly and adjacently connected along the second lengthwise edge;
the first tapered panel and the second tapered panel being positioned in between the first lengthwise edge and the second lengthwise edge;
the first tapered panel being terminally connected to the base panel;
the second tapered panel being terminally connected to the base panel, opposite the first tapered panel;
the first tapered panel, the second tapered panel, and the base panel being positioned coplanar to each other;
the first lateral-bracing portion and the second lateral-bracing portion being positioned offset to each other by a part-receiving gap;
the outer panel being positioned perpendicular to the base panel;
the top panel being positioned parallel to the base panel;
the inner panel being positioned perpendicular to the base panel;
the bottom panel being positioned parallel to the base panel;
the bottom panel being pressed against the base panel;
the first orifice and the second orifice being positioned offset from each other along the part-receiving gap;
the first orifice and the second orifice traversing through the first lateral-bracing portion and the second lateral-bracing portion; and
the first orifice and the second orifice intersecting the part-receiving gap.

17. The part-gripping carrier as claimed in claim 16 comprises:
the outer panel of the first lateral-bracing portion being foldably and adjacently connected to the first lengthwise edge;
the top panel of the first lateral-bracing portion being foldably and adjacently connected to the outer panel of the first lateral-bracing portion, opposite the first lengthwise edge;
the outer panel of the second lateral-bracing portion being foldably and adjacently connected to the second lengthwise edge;
the top panel of the second lateral-bracing portion being foldably and adjacently connected to the outer panel of the second lateral-bracing portion, opposite the second lengthwise edge;
the inner panel being foldably and adjacently connected to the top panel, opposite the outer panel; and
the bottom panel being foldably and adjacently connected to the inner panel, opposite the top panel.

18. The part-gripping carrier as claimed in claim 16 comprises:
the first lateral-bracing portion and the second lateral-bracing portion each further comprise a first folding tab and a second folding tab;
the first folding tab and the second folding tab being positioned in between the base panel and the top panel;
the first folding tab being peripherally and foldably connected to the outer panel; and
the second folding tab being peripherally and foldably connected to the outer panel, opposite the first folding tab.

19. The part-gripping carrier as claimed in claim 16 comprises:
the top panel, the inner panel, and the bottom panel each comprise a first widthwise edge and a second widthwise edge;
the first widthwise edge being positioned adjacent to the first tapered panel;
the first widthwise edge of the inner panel being positioned perpendicular to the first lengthwise;
the first widthwise edge of the top panel being oriented at a top acute angle with the first lengthwise edge;
the first widthwise edge of the bottom panel being oriented at a bottom acute angle with the first lengthwise edge;
the top acute angle and the bottom acute angle being equal and opposite to each other;
the second widthwise edge being positioned adjacent to the second tapered panel;
the second widthwise edge of the inner panel being positioned perpendicular to the first lengthwise;
the second widthwise edge of the top panel being oriented at a top acute angle with the first lengthwise edge;
the second widthwise edge of the bottom panel being oriented at a bottom acute angle with the first lengthwise edge; and
the top acute angle and the bottom acute angle being equal and opposite to each other.

20. The part-gripping carrier as claimed in claim 16 comprises:
a plurality of first orifices;
a plurality of second orifices;
the plurality of first orifices traversing into the first lateral-bracing portion;
the plurality of first orifices being positioned adjacent to the first lengthwise edge;
the plurality of first orifices being distributed along the first lengthwise edge;
the plurality of second orifices traversing into the second lateral-bracing portion;
the plurality of second orifices being positioned adjacent to the second lengthwise edge; and
the plurality of second orifices being distributed along the second lengthwise edge.
